(19) United States
(12) Patent Application Publication
(10) Pub. No.: US 2026/0045684 A1
(43) Pub. Date: Feb. 12, 2026

(54) ANTENNA MODULE AND COMMUNICATION APPARATUS INCLUDING THE SAME

(71) Applicant: Murata Manufacturing Co., Ltd., Nagaokakyo-shi (JP)

(72) Inventor: Ryo KOMURA, Nagaokakyo-shi (JP)

(73) Assignee: Murata Manufacturing Co., Ltd., Nagaokakyo-shi (JP)

(21) Appl. No.: 19/363,699

(22) Filed: Oct. 21, 2025

Related U.S. Application Data
(63) Continuation of application No. PCT/JP2024/016694, filed on Apr. 30, 2024.

(30) Foreign Application Priority Data
Jun. 22, 2023 (JP) 2023-102567

(51) Int. Cl. H01Q 1/52; H01Q 1/22; H01Q 9/04

(52) U.S. Cl. CPC H01Q 1/523; H01Q 1/22; H01Q 9/0407

(57) ABSTRACT

An antenna module includes a dielectric substrate, a planar radiating element, first and second ground electrodes), and first and second feed lines. The first ground electrode faces the radiating element in a direction of a line normal to the dielectric substrate. The first and second feed lines are separated from each other and arranged to transfer radio-frequency signals to separate feed points of the radiating element. The second ground electrode protrudes from the first ground electrode and is at least partially disposed along the first feed line. At least part of the second ground electrode is disposed along the radiating element. The dimension of a connecting portion of the second ground electrode with the first ground electrode in the second direction is smaller than the dimension of the second ground electrode in the first direction.

### CROSS-REFERENCE TO RELATED APPLICATIONS

The present application is a bypass continuation of International Application No. PCT/JP2024/016694, filed Apr. 30, 2024, which claims priority to Japanese patent application JP 2023-102567, filed Jun. 22, 2023, the entire contents of each of which being incorporated herein by reference.

### TECHNICAL FIELD

The present disclosure relates to an antenna module and a communication apparatus including the same, and, more particularly, to a technology for improving the isolation between polarized waves in a dual-polarization antenna device.

### BACKGROUND ART

Japanese Unexamined Patent Application Publication No. 2022-123216 (Patent Document 1) discloses the following antenna device. This antenna device includes a ground conductor that is disposed to surround at least part of the peripheral portion of a planar radiating conductor. In the antenna device disclosed in Patent Document 1, feed lines extending toward the radiating conductor are each sandwiched by the ground conductor from both sides and are connected to the radiating conductor by feed coupling portions that are wider than the feed lines.

### CITATION LIST

### Patent Document

Patent Document 1: Japanese Unexamined Patent Application Publication No. 2022-123216

### SUMMARY

### Technical Problems

In the antenna device disclosed in Patent Document 1, the radiating conductor has a substantially square shape, and one feed line is connected to a side of the radiating conductor adjacent to this feed line, while the other feed line is connected to another side of the radiating conductor adjacent to this feed line. The feed lines and the ground conductor form a coplanar line. That is, this antenna device is what is known as a dual-polarization antenna device that can radiate radio waves in different polarization directions.

In the antenna device disclosed in Patent Document 1, the ground conductor is continuously provided between the two feed lines. In this case, a current distribution is generated in the ground conductor between the feed lines, thereby coupling the two feed lines with each other. This may degrade the isolation between the feed lines.

The present disclosure has been made to solve this problem. It is an object of the disclosure to improve the isolation between polarized waves in a dual-polarization antenna device.

### Solution to Problem

An antenna module according to an aspect of the present disclosure includes a dielectric substrate, a radiating element, first and second ground electrodes, and first and second feed lines. The radiating element has a planar shape and is disposed in or on the dielectric substrate. The first ground electrode is disposed at a position at which it faces the radiating element when the dielectric substrate is seen in a direction of a line normal to the dielectric substrate. The first feed line is disposed along a first direction, the first direction being a direction from the first ground electrode toward the radiating element, and transfers a radio-frequency signal to a first feed point of the radiating element. The second feed line is separated from the first feed line and is disposed along the first direction and transfers a radio-frequency signal to a second feed point of the radiating element. The second ground electrode protrudes from the first ground electrode and is at least partially disposed along the first feed line. The first feed point and the second feed point are shifted in different directions with respect to a center of the radiating element. When a direction from the first feed line toward the second feed line is set to a second direction and when a direction from the second feed line toward the first feed line is set to a third direction, the second ground electrode is separated from the first feed line in the third direction. At least part of the second ground electrode is disposed along the radiating element. A size of a connecting portion of the second ground electrode with the first ground electrode in the second direction is smaller than a size of the second ground electrode in the first direction.

An antenna module according to another aspect of the present disclosure includes a dielectric substrate, first and second radiating elements, first and fifth ground electrodes, and first through fourth feed lines. The first and second radiating elements have a planar shape and are disposed separately from each other in or on the dielectric substrate. The first ground electrode is disposed at a position at which it faces the first and second radiating elements when the dielectric substrate is seen in a direction of a line normal to the dielectric substrate. The first feed line is disposed along a first direction, the first direction being a direction from the first ground electrode toward the first radiating element, and transfers a radio-frequency signal to a first feed point of the first radiating element. The second feed line is separated from the first feed line and is disposed along the first direction and transfers a radio-frequency signal to a second feed point of the first radiating element. The third feed line is disposed along the first direction, the first direction also being a direction from the first ground electrode toward the second radiating element, and transfers a radio-frequency signal to a third feed point of the second radiating element. The fourth feed line is separated from the third feed line and is disposed along the first direction and transfers a radio-frequency signal to a fourth feed point of the second radiating element. When a direction from the first radiating element toward the second radiating element is set to a second direction, the second feed line is disposed farther toward the second radiating element in the second direction than the first feed line is, and the fourth feed line is disposed farther toward the second radiating element in the second direction than the third feed line is. The first feed point and the second feed point are shifted in different directions with respect to a center of the first radiating element. The third feed point and the fourth feed point are shifted in different directions with respect to a center of the second radiating element. A fifth ground electrode protrudes from the first ground electrode and is disposed between the second feed line and the third feed line. A size of a connecting portion of the fifth ground electrode with the first ground electrode in the second direction is smaller than a size of the fifth ground electrode in the first direction. The fifth ground electrode includes a first portion disposed along the second feed line, a second portion disposed along the third feed line, a third portion disposed along the first radiating element, and a fourth portion disposed along the second radiating element.

### Advantageous Effects

An antenna module of the present disclosure implements the following dual-polarization antenna module. A strip-like ground electrode (second ground electrode) is provided to be at least partially disposed along both of a feed line and a radiating element. With this configuration, a radio-frequency signal flowing through the feed line resonates with the ground electrode, thereby reducing the occurrence of coupling between this feed line and the other feed line. It is thus possible to improve the isolation between polarized waves in the dual-polarization antenna module.

### BRIEF DESCRIPTION OF DRAWINGS

FIG. 1 is an overall schematic diagram of a communication apparatus to which an antenna module of a first embodiment is applied.

FIG. 2 is a plan view of the antenna module according to the first embodiment.

FIG. 3 is a diagram for explaining the resonance in a ground electrode GND2.

FIG. 4 is a plan view of an antenna module according to a comparative example.

FIG. 5 is a graph illustrating the antenna characteristics of the antenna module of the first embodiment.

FIG. 6 illustrates modified examples of the ground electrode GND2.

FIG. 7 shows plan views of antenna modules according to a second embodiment.

FIG. 8 is a graph illustrating the antenna characteristics of the antenna modules of the second embodiment.

FIG. 9 is a plan view of an antenna module according to a third embodiment.

FIG. 10 is a graph illustrating the antenna characteristics of an antenna module of a third embodiment.

### DESCRIPTION OF EMBODIMENTS

Embodiments of the present disclosure will be described below in detail with reference to the drawings. The same or corresponding elements in the drawings are designated by like reference numeral and an explanation thereof will not be repeated.

### First Embodiment

### (Basic Configuration of Communication Apparatus)

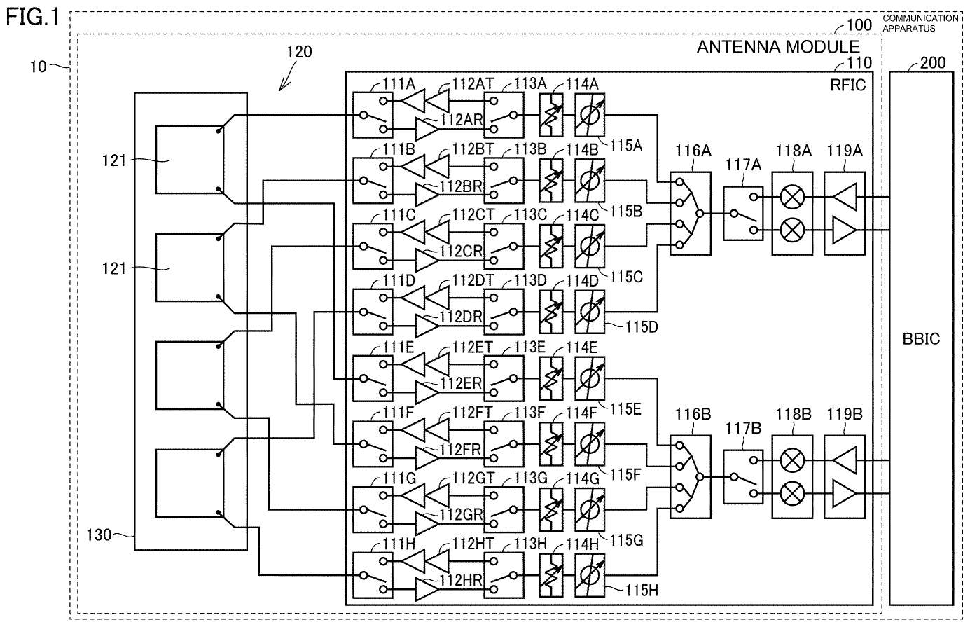

FIG. 1 is a block diagram of a communication apparatus 10 to which an antenna module 100 of a first embodiment is applied. The communication apparatus 10 is, for example, a mobile terminal, such as a mobile phone, a smartphone, or a tablet, or a personal computer having a communication function. An example of the frequency band of a radio wave used in the antenna module 100 of the first embodiment is millimeter bands, such as those having 28 GHZ, 39 GHZ, and 60 GHZ, for example, as the center frequency. A frequency band other than the above-described millimeter bands may be applied to a radio wave used in the antenna module 100.

As illustrated in FIG. 1, the communication apparatus 10 includes the antenna module 100 and a BBIC 200 that forms a baseband signal processing circuit. The antenna module 100 includes an RFIC 110 and an antenna device 120. The RFIC 110 is an example of a feeder circuit that supplies a radio-frequency signal to the antenna device 120. The communication apparatus 10 up-converts a signal, which is transferred from the BBIC 200 to the antenna module 100, into a radio-frequency signal and radiates it from the antenna device 120. The communication apparatus 10 also down-converts a radio-frequency signal received by the antenna device 120 and processes the down-converted signal by using the BBIC 200.

The antenna device 120 includes a dielectric substrate 130 having a planar shape and at least one radiating element 121 disposed on the dielectric substrate 130. In the example in FIG. 1, four radiating elements 121 are disposed on the dielectric substrate 130. However, the number of radiating elements is not limited to four. Additionally, in the example in FIG. 1, the radiating elements are aligned and arranged in a linear array form on the dielectric substrate. However, the radiating elements may be arranged in a two-dimensional array form on the dielectric substrate. Alternatively, a radiating element may be disposed solely on the dielectric substrate. In the first embodiment, the radiating elements 121 are planar patch antennas having a substantially square shape.

The antenna device 120 is what is known as a dual-polarization antenna device that can radiate two radio waves in different polarization directions from one radiating element 121. Each radiating element 121 receives a first-polarization radio-frequency signal and a second-polarization radio-frequency signal from the RFIC 110.

The RFIC 110 includes switches 111A through 111H, 113A thorough 113H, 117A, and 117B, power amplifiers 112AT through 112HT, low-noise amplifiers 112AR through 112HR, attenuators 114A through 114H, phase shifters 115A through 115H, signal combiners/splitters 116A and 116B, mixers 118A and 118B, and amplifier circuits 119A and 119B. Among these elements, the switches 111A through 111D, 113A through 113D, and 117A, power amplifiers 112AT through 112DT, low-noise amplifiers 112AR through 112DR, attenuators 114A through 114D, phase shifters 115A through 115D, signal combiner/splitter 116A, mixer 118A, and amplifier circuit 119A form a circuit for the first-polarization radio-frequency signal. The switches 111E through 111H, 113E through 113H, and 117B, power amplifiers 112ET through 112HT, low-noise amplifiers 112ER through 112HR, attenuators 114E through 114H, phase shifters 115E through 115H, signal combiner/splitter 116B, mixer 118B, and amplifier circuit 119B form a circuit for the second-polarization radio-frequency signal.

When transmitting a radio-frequency signal, the switches 111A through 111H and 113A through 113H are respectively switched to the power amplifiers 112AT through 112HT, and the switches 117A and 117B are respectively connected to transmit amplifiers of the amplifier circuits 119A and 119B. When receiving a radio-frequency signal, the switches 111A through 111H and 113A through 113H are respectively switched to the low-noise amplifiers 112AR through 112HR, and the switches 117A and 117B are respectively connected to receive amplifiers of the amplifier circuits 119A and 119B.

Signals transferred from the BBIC 200 are amplified in the amplifier circuits 119A and 119B and are up-converted to radio-frequency signals in the mixers 118A and 118B. Transmission signals, which are the up-converted radio-frequency signals, are each split into four signals in the corresponding signal combiners/splitters 116A and 116B. The four signals split in the combiner/splitter 116A pass through the corresponding signal paths and are supplied to different radiating elements 121. The four signals split in the combiner/splitter 116B also pass through the corresponding signal paths and are supplied to the different radiating elements 121A and 121B. The phase shifting degrees in the phase shifters 115A through 115H disposed in the signal paths are individually adjusted, thereby making it possible to control the directivity of a radio wave to be output from each of the radiating element. The attenuators 114A through 114H adjust the strength of the transmission signals.

Reception signals, which are radio-frequency signals received by the radiating elements 121, are transferred to the RFIC 110, pass through the four different signal paths, and are combined in the signal combiner/splitter 116A. Likewise, reception signals received by the radiating elements 121 are transferred to the RFIC 110, pass through the four different signal paths, and are combined in the signal combiner/splitter 116B. The combined reception signals are down-converted in the mixers 118A and 118B and are amplified in the amplifier circuit 119A and 119B, and are then transferred to the BBIC 200.

The RFIC 110 is formed as, for example, a one-chip integrated circuit component including the above-described circuit configuration. Alternatively, one-chip integrated circuit component may be formed for each radiating element 121 in the following manner. Devices (switches, power amplifiers, low-noise amplifiers, attenuators, and phase shifters) of the RFIC 110 which correspond to the same radiating element 121 may be formed as a one-chip integrated circuit component.

### (Configuration of Antenna Module)

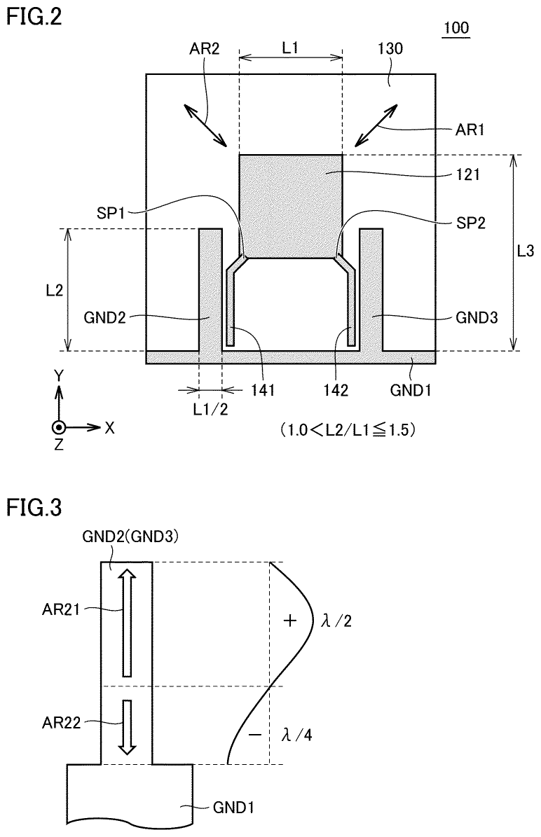

The detailed configuration of the antenna module 100 of the first embodiment will be described below with reference to FIG. 2. FIG. 2 is a plan view of the antenna module 100 according to the first embodiment.

The antenna module 100 includes feed lines 141 and 142 and ground electrodes GND1 through GND3, as well as the radiating element 121, dielectric substrate 130, and RFIC 110. In the following explanation, a direction of a line normal to the dielectric substrate 130 (radiating direction of a radio wave) is set to be the Z-axis direction, and a plane perpendicular to the Z-axis direction is defined by the X axis and the Y axis.

The dielectric substrate 130 is a low temperature co-fired ceramics (LTCC) multilayer substrate, a multilayer resin substrate formed by stacking multiple resin layers made of a resin, such as an epoxy or polyimide resin, a multilayer resin substrate formed by stacking multiple resin layers made of a liquid crystal polymer (LCP) having a lower dielectric constant, a multilayer resin substrate formed by stacking multiple resin layers made of a fluorine resin, a multilayer resin substrate formed by stacking multiple resin layers made of a PET (Polyethylene Terephthalate) material, or a ceramics multilayer substrate made of ceramics other than the LTCC. The dielectric substrate 130 may be a single layer substrate instead of a multilayer substrate.

The dielectric substrate 130 has a rectangular shape as viewed from the direction of a line normal to the dielectric substrate 130 (Z-axis direction). In the example in FIG. 2, the radiating element 121 is disposed on the top surface of the dielectric substrate 130 (the surface in the positive direction of the Z axis). The radiating element 121 may be exposed on the front side of the dielectric substrate 130 as shown in FIG. 2 or may be disposed inside the dielectric substrate 130. The radiating element 121 having a substantially square shape is disposed so that its individual side becomes parallel with the X axis or the Y axis in FIG. 2.

A ground electrode is provided on the entire bottom surface (the surface in the negative direction of the Z axis) of the dielectric substrate 130 so as to oppose the radiating element 121. The radiating element 121 and this ground electrode form an microstrip antenna. The RFIC 110 is mounted on the bottom surface of the dielectric substrate 130.

A radio-frequency signal is transferred from the RFIC 110 to the radiating element 121 via the feed lines 141 and 142. The feed lines 141 and 142 extend through the dielectric substrate 130 from the RFIC 110 in the Z-axis direction, pass through the top surface of the dielectric substrate 130, and are connected to the radiating element 121.

More specifically, the feed line 141 rises to the top surface of the dielectric substrate 130 at a position near the end portion of the dielectric substrate 130 in the negative direction of the Y axis, extends in the positive direction of the Y axis, and is connected to a feed point SP1 at one corner of the radiating element 121. Likewise, the feed line 142 rises to the top surface of the dielectric substrate 130 at a position near the end portion of the dielectric substrate 130 in the negative direction of the Y axis, extends in the positive direction of the Y axis, and is connected to a feed point SP2, which is another corner of the radiating element 121, adjacent to the feed point SP1. That is, the feed points SP1 and SP2 are shifted in different directions with respect to the center of the radiating element 121. The feed line 142 is separated from the feed line 141 and is located at a position farther toward the positive side of the X-axis direction than the feed line 141.

Supplying a radio-frequency signal to the feed point SP1 can radiate a radio wave in the positive direction of the Z axis. The polarization direction of this radio wave is the direction of one of the diagonal lines of the radiating element 121, as indicated by the arrow AR1 in FIG. 2. Supplying a radio-frequency signal to the feed point SP2 can radiate a radio wave in the positive direction of the Z axis. The polarization direction of this radio wave is the direction of the other one of the diagonal lines of the radiating element 121, as indicated by the arrow AR2 in FIG. 2. That is, the antenna module 100 is what is known as a dual-polarization antenna device that can radiate two radio waves in different polarization directions from one radiating element 121.

The ground electrode GND1 is disposed along the end portion of the top surface of the dielectric substrate 130 in the negative direction of the Y axis. The ground electrode GND1 is connected to the above-described ground electrode provided on the bottom surface of the dielectric substrate 130 by using a via extending in the direction of a line normal to the dielectric substrate 130 or a side electrode disposed on a side surface of the dielectric substrate 130. The ground electrode GND1 is located to face one side of the radiating element 121. The feed lines 141 and 142 are located in the area between the ground electrode GND1 and the radiating element 121.

The ground electrodes GND2 and GND3 are strip-like electrodes having a substantially rectangular shape and protrude from the ground electrode GND1 in the positive direction of the Y axis. In other words, the size of the connecting portion of each of the ground electrodes GND2 and GND3 with the ground electrode GND1 in the X-axis direction is smaller than the size of each of the ground electrodes GND2 and GND3 in the Y-axis direction. The ground electrode GND2 is disposed in proximity to the feed line 141 and the radiating element 121 at a position farther toward the negative side of the X-axis direction than the feed line 141. Part of the ground electrode GND2 extends in parallel with the portion of the feed line 141 extending in the Y-axis direction.

The ground electrode GND3 is disposed in proximity to the feed line 142 and the radiating element 121 at a position farther toward the positive side of the X-axis direction than the feed line 142. Part of the ground electrode GND3 extends in parallel with the portion of the feed line 142 extending in the Y-axis direction.

The end portions of the ground electrodes GND2 and GND3 in the positive direction of the Y axis face the sides of the radiating element 121 extending along the Y axis. The ground electrodes GND2 and GND3 are capacitively coupled at these end portions with the radiating element 121.

When the size of the radiating element 121, that is, the length of one side, is represented by L1, the width (that is, the dimension in the X-axis direction) of each of the ground electrodes GND2 and GND3 is set to be smaller than or equal to ½ of L1. When the distance from the ground electrode GND1 to the farthest end of each of the ground electrodes GND2 and GND3 in the Y-axis direction, that is, the length of the protruding portion (the dimension in the Y-axis direction) of each of the ground electrodes GND2 and GND3 from the ground electrode GND1, is represented by L2, L2 is set to be larger than L1, which is the length of one side of the radiating element 121, and smaller than or equal to 1.5 times as large as L1 (1.0<L2/L1≤1.5). Additionally, the length L2 of the protruding portion of each of the ground electrodes GND2 and GND3 is shorter than L3, which is equal to the distance from the ground electrode GND1 to the farthest end of the radiating element 121.

When the feed lines 141 and 142 are disposed in parallel with each other on the top surface of the dielectric substrate 130 as discussed above, the two feed lines are unfavorably coupled with each other, which may degrade the isolation between two polarized waves. As in the above-described Japanese Unexamined Patent Application Publication No. 2022-123216 (Patent Document 1), in the configuration in which a ground electrode is disposed on the entire area between two feed lines, a current distribution is generated in the ground electrode and couples the feed lines with each other. This may also degrade the isolation.

In the antenna module 100 of the first embodiment, the ground electrodes GND2 and GND3 having a predetermined length of a strip-like narrow shape are respectively disposed along the feed lines 141 and 142, and also, the ground electrodes GND2 and GND3 are partially coupled with the radiating element 121.

By forming the ground electrodes GND2 and GND3 in such a shape, the ground electrodes GND2 and GND3 can serve as resonators by inductance components of the ground electrodes GND2 and GND3 and capacitance components between the ground electrodes GND2 and GND3 and the radiating element 121. Because of the resonance of the ground electrodes GND2 and GND3, signal components corresponding to the resonant frequency of a radio-frequency signal passing through the feed lines 141 and 142 can concentrate on the ground electrodes GND2 and GND3 so as to prevent from coupling the feed lines 141 and 142 with each other. In other words, due to the resonance of the ground electrodes GND2 and GND3, currents at the resonant frequency are induced primarily on these electrodes, which confines the associated electromagnetic fields and thereby reduces electromagnetic coupling between the feed lines 141 and 142. As a result, the isolation between polarized waves is not degraded.

More specifically, as shown in FIG. 3, the length L2 of each of the ground electrodes GND2 and GND3 in the Y-axis direction is set to be the length which allows the ground electrodes GND2 and GND3 to generate the third-harmonic resonance that matches the frequency at which the isolation is desired to be improved. In other words, when the frequency at which the isolation is desired to be improved is represented by f, L2 is set to be ¼ of the wavelength of the frequency f/3. That is, L2 is set to be the length of ¾ of the wavelength λ of the frequency f. In this case, as indicated by the arrows AR21 and AR22 in FIG. 3, a transition point is generated in the mid portion of each of the ground electrodes GND2 and GND3, so that the current phase is inverted.

When the effective wavelength, i.e., the wavelength of the signal within the dielectric substrate, of a radio wave emitted from the radiating element 121 within the dielectric substrate 130 is represented by λ, the size of the radiating element 121 (length of one side) is set to be λ/2, and the largest length L2 of each of the ground electrodes GND2 and GND3 is about 1.5 times as large as the size of the radiating element 121. As discussed above, the resonant frequency of the ground electrodes GND2 and GND3 is determined by the inductance components of the ground electrodes GND2 and GND3 and the capacitance components between the ground electrodes GND2 and GND3 and the radiating element 121. Hence, as the amount of capacitive coupling between the ground electrodes GND2 and GND3 and the radiating element 121 is greater, the length L2 of the ground electrodes GND2 and GND3 becomes shorter. The length L2 is thus set to be larger than the size of the radiating element 121 and is smaller than or equal to 1.5 times as large as the size of the radiating element 121.

### (Antenna Characteristics)

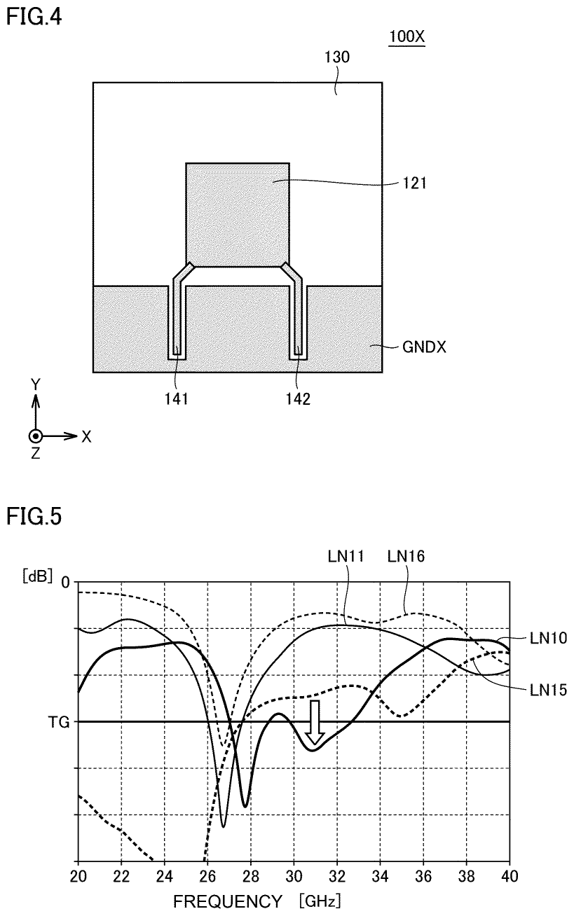

The antenna characteristics of the antenna module of the first embodiment will be discussed below with the use of a comparative example. FIG. 4 is a plan view of an antenna module 100X according to a comparative example. FIG. 5 is a graph illustrating the antenna characteristics of the antenna module 100 of the first embodiment.

FIG. 4 shows that, regarding the antenna module 100X of the comparative example, the arrangement of the radiating element 121 and the feed lines 141 and 142 on the dielectric substrate 130 is similar to that of the antenna module 100. In contrast, in the antenna module 100X, as in Japanese Unexamined Patent Application Publication No. 2022-123216 (Patent Document 1), a ground electrode GNDX is disposed to surround the feed lines 141 and 142 in the entire area of part of the dielectric substrate 130 which is farther toward the negative side of the Y-axis direction than the radiating element 121.

FIG. 5 shows the insertion loss incurred from the feed line 141 to the feed line 142, that is, the characteristics of the isolation between the feed lines, and the return loss of the antenna module 100 and those of the antenna module 100X. In FIG. 5, the solid line LN10 indicates the isolation characteristics of the antenna module 100 of the first embodiment, while the solid line LN11 indicates the return loss of the antenna module 100. The broken line LN15 indicates the isolation characteristics of the antenna module 100X of the comparative example, while the broken line LN16 indicates the return loss of the antenna module 100X.

In the example in FIG. 5, the frequency band of a radio wave emitted from the radiating element 121 is a 28-GHz band (26.5 to 29.5 GHZ). The isolation is improved by aiming at around 31 GHZ, which is close to the 28-GHz band. This can improve the isolation without impairing the radiation of a radio wave of the target frequency band. In the example in FIG. 5, the dB value of the target isolation is indicated by TG.

FIG. 5 shows that the dB value representing the isolation of the antenna module 100X of the comparative example around 31 GHz considerably exceeds the target value (broken line LN15). In contrast, the isolation of the antenna module 100 of the first embodiment around 31 GHz is improved up to the target level (solid line LN10).

When a radio-frequency signal is supplied to the feed line 141, the isolation in the area from the feed line 141 to the feed line 142 is improved by the ground electrode GND2. When a radio-frequency signal is supplied to the feed line 142, the isolation in the area from the feed line 142 to the feed line 141 is improved by the ground electrode GND3. If only one of the ground electrodes GND2 and GND3 is disposed, the electrical symmetry is disturbed and the cross polarization discrimination may be degraded.

As described above, a ground electrode is disposed along a feed line that transfers a radio-frequency signal. The length of the ground electrode is set to be a length that allows for the generation of the third-harmonic wave that matches the frequency at which the isolation is desired to be improved. Additionally, part of the ground electrode is capacitively coupled with a radiating element. With this configuration, the ground electrode can serve as a resonator, thereby preventing a signal of a desired frequency from coupling the above-described feed line with the other feed line. As a result, the isolation between the feed lines can be improved.

### Modified Examples

In the above-described antenna module 100, the ground electrodes GND2 and GND3, which operate as resonators, are linear electrodes extending in the Y-axis direction. However, the ground electrodes GND2 and GND3 are not limited to linear electrodes if they include a linear portion having a length equivalent to the distance from the ground electrode GND1 to the farthest end of each of the ground electrodes GND2 and GND3.

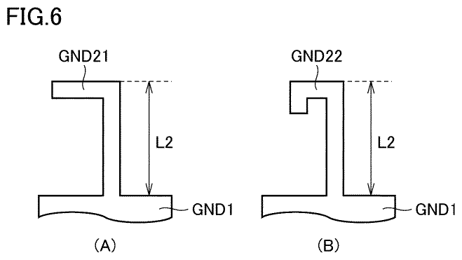

For example, the ground electrodes GND2 and GND3 may be formed as a ground electrode GND21 having a substantially “L” shape, such as that shown in FIG. 6(A) on the left side, or as a ground electrode GND22 having a substantially “J” shape, such as that shown in FIG. 6(B) on the right side. In both configurations in FIG. 6, the ground electrodes GND21 and GND22 each includes a linear portion having a length equivalent to the distance L2 from the ground electrode GND1 to the farthest end of the ground electrode GND21 or GND22. The third harmonic resonance is generated in this linear portion. Using the ground electrodes shown in FIG. 6 can also improve the isolation at a target frequency, as in the antenna module 100.

“Ground electrodes GND1 through GND3” in the first embodiment respectively correspond to an example of “first ground electrode”, “second ground electrode”, and “third ground electrode” in the disclosure. “Feed line 141” and “feed line 142” in the first embodiment respectively correspond to an example of “first feed line” and “second feed line” in the disclosure. “Feed point SP1” and “feed point SP2” in the first embodiment respectively correspond to an example of “first feed point” and “second feed point” in the disclosure. “Positive direction of the Y axis” in the first embodiment corresponds to “first direction” in the disclosure. “Positive direction of the X axis” in the first embodiment corresponds to “second direction” in the disclosure. “Negative direction of the X axis” in the first embodiment corresponds to “third direction” in the disclosure.

### Second Embodiment

In a second embodiment, an explanation will be given of the configuration in which another ground electrode is disposed between two feed lines.

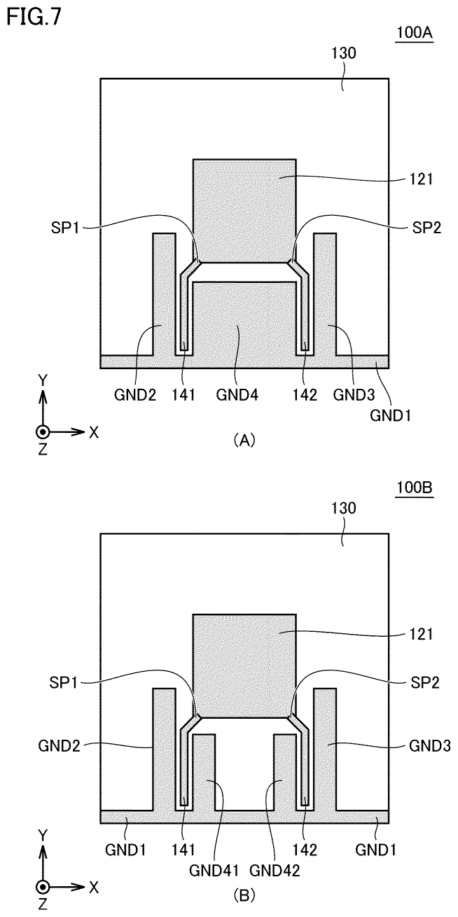

FIG. 7 shows plan views of antenna modules 100A and 100B according to the second embodiment.

In the antenna module 100A in FIG. 7(A) on the upper side, one ground electrode GND4 is disposed in the area between the feed lines 141 and 142. The ground electrode GND4 protrudes from the ground electrode GND1 in the positive direction of the Y axis and is located in the entire area between the feed lines 141 and 142. The end portion of the ground electrode GND4 in the negative direction of the X axis closely faces the portion of the feed line 141 extending along the Y axis. The end portion of the ground electrode GND4 in the positive direction of the X axis closely faces the portion of the feed line 142 extending along the Y axis.

With the provision of the ground electrode GND4 configured as described above, the portions of the ground electrode GND4 on the top surface of the dielectric substrate 130 which extend along the feed lines 141 and 142 in the Y-axis direction can form a coplanar line, thereby making it possible to adjust the impedance of the feed lines 141 and 142. It is thus possible to reduce the occurrence of unwanted waves to be radiated from the feed lines, which would be caused by the impedance mismatching between the feed lines 141 and 142 and the radiating element 121. This can improve the directivity of a radio wave toward the front side of the radiating element (direction of a line normal to the dielectric substrate).

In the antenna module 100B in FIG. 7(B) on the lower side, an individual ground electrode is provided for each of the feed lines 141 and 142 in the area between the feed lines 141 and 142. More specifically, for the feed line 141, a strip-like ground electrode GND41 is disposed along the feed line 141, while, for the feed line 142, a strip-like ground electrode GND42 is disposed along the feed line 142. The size of each of the ground electrodes GND41 and GND42 in the X-axis direction is smaller than that in the Y-axis direction.

In the antenna module 100B, too, the feed line 141 and the ground electrodes GND2 and GND41 form a coplanar line, while the feed line 142 and the ground electrodes GND3 and GND42 form a coplanar line. This can adjust the impedance of the feed lines 141 and 142, as in the antenna module 100A. It is thus possible to suppress the degradation of the directivity resulting from the occurrence of unwanted waves, which would be caused by impedance mismatching between the feed lines 141 and 142 and the radiating element 121.

### (Antenna Characteristics)

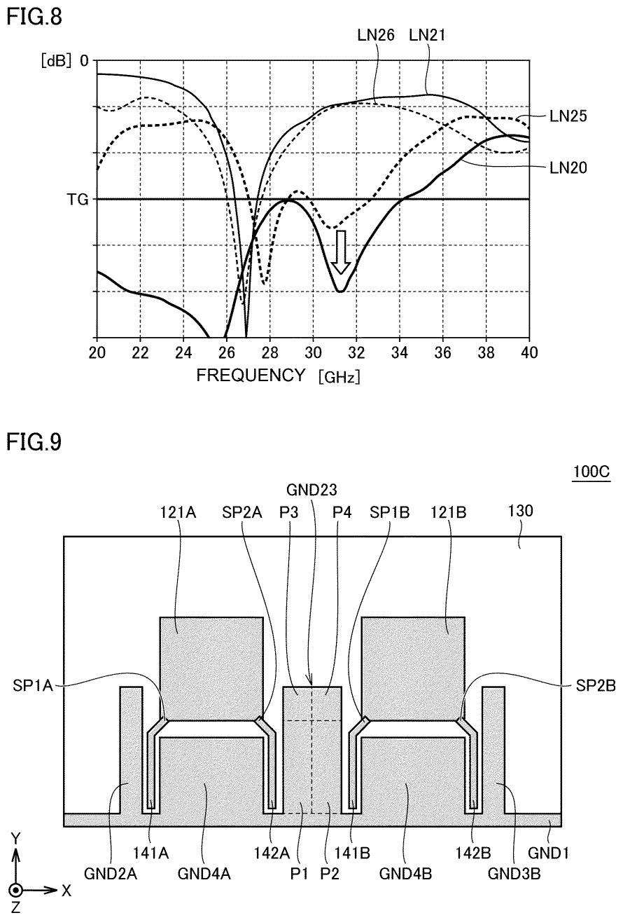

FIG. 8 is a graph illustrating the antenna characteristics of the antenna modules according to the second embodiment. FIG. 8 shows the isolation characteristics (broken line LN25) and the return loss (broken line LN26) of the antenna module 100 of the first embodiment and the isolation characteristics (solid line LN20) and the return loss (solid line LN21) of the antenna module 100A of the second embodiment.

As is seen from FIG. 8, the isolation of the antenna module 100A around 31 GHz is even better than that of the antenna module 100 of the first embodiment. Suitably adjusting the impedance of the feed lines by forming the feed lines as coplanar lines can improve the directivity.

“Ground electrode GND4” and “ground electrodes GND41 and GND42” in the second embodiment each correspond to an example of “fourth ground electrode” in the disclosure. “Ground electrode GND41” and “ground electrode GND42” in the second embodiment respectively correspond to an example of “first electrode” and “second electrode” in the disclosure.

### Third Embodiment

In a third embodiment, an array antenna incorporating the features of the disclosure will be explained below.

FIG. 9 is a plan view of an antenna module 100C according to the third embodiment. Regarding the antenna module 100C, an explanation will be given of an example of the configuration in which two radiating elements are disposed on the dielectric substrate 130 in the X-axis direction. Three or more radiating elements may be disposed. Multiple radiating elements may be arranged in a two-dimensional array form.

As illustrated in FIG. 9, radiating elements 121A and 121B are disposed separately from each other in the X-axis direction on the dielectric substrate 130. The radiating element 121B is disposed farther toward the positive side of the X-axis direction than the radiating element 121A is. As in the antenna module 100 of the first embodiment, feed lines 141A and 142A are connected to feed points SP1A and SP2A, respectively, of the radiating element 121A. Feed lines 141B and 142B are connected to feed points SP1B and SP2B, respectively, of the radiating element 121B.

On the negative side of the X-axis direction of the feed line 141A connected to the radiating element 121A, a strip-like ground electrode GND2A is disposed along the feed line 141A. On the positive side of the X-axis direction of the feed line 142B connected to the radiating element 121B, a strip-like ground electrode GND3B is disposed along the feed line 142B.

A strip-like ground electrode GND23 is disposed between the feed line 142A connected to the radiating element 121A and the feed line 141B connected to the radiating element 121B. The ground electrode GND23 includes a first portion P1 located along the feed line 142A, a second portion P2 located along the feed line 141B, a third portion P3 located along the radiating element 121A, and a fourth portion P4 located along the radiating element 121B.

The size of the connecting portion of each of the ground electrodes GND2A, GND23, and GND3B with the ground electrode GND1 in the X-axis direction is smaller than the size of each of the ground electrodes GND2A, GND23, and GND3B in the Y-axis direction.

For the radiating element 121A, the ground electrode GND23 can serve like the ground electrode GND3 of the antenna module 100, and, for the radiating element 121B, the ground electrode GND23 can serve like the ground electrode GND2 of the antenna module 100. If the dimension of the ground electrode GND23 in the X-axis direction is larger, an electrode for the feed line 142A and an electrode for the feed line 141B may be individually provided.

A ground electrode GND4A, which is similar to that discussed in the second embodiment with reference to FIG. 7, is disposed in the area between the feed lines 141A and 142A connected to the radiating element 121A. A ground electrode GND4B is disposed in the area between the feed lines 141B and 142B connected to the radiating element 121B.

In the antenna module 100C, too, the provision of the ground electrodes GND2A, GND23, and GND3B can improve the isolation between the feed lines for each radiating element. The provision of the ground electrodes GND4A and GND4B can adjust the impedance between the radiating elements and the feed lines. It is thus possible to reduce the occurrence of unwanted waves, which would be caused by impedance mismatching, and thereby to improve the directivity.

### (Antenna Characteristics)

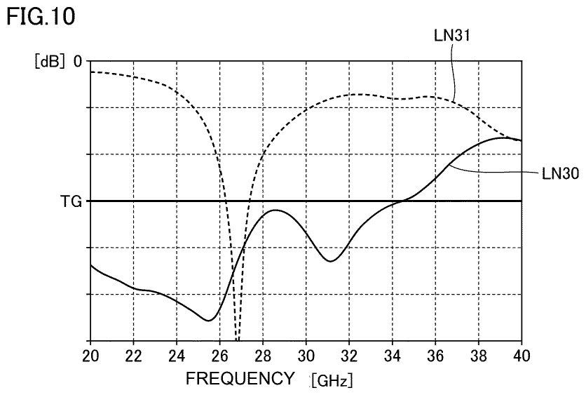

FIG. 10 is a graph illustrating the antenna characteristics of the antenna module 100C according to the third embodiment. FIG. 10 shows the isolation characteristics (solid line LN30) and the return loss (broken line LN31) of each radiating element. Since the antenna module 100C has a symmetrical structure, the antenna characteristics of the radiating element 121A and those of the radiating element 121B match each other.

In FIG. 10, too, the dB value of each radiating element that represents the isolation characteristics is lower than the target value. The provision of the ground electrodes GND2A, GND23, and GND3B can improve the isolation between the feed lines.

As described above, in the array antenna, too, with the application of the features of the disclosure, the isolation between feed lines can be improved.

“Radiating element 121A” and “radiating element 121B” in the third embodiment respectively correspond to an example of “first radiating element” and “second radiating element” in the disclosure. “Feed line 141A”, “feed line 142A”, “feed line 141B”, and “feed line 142B” in the third embodiment respectively correspond to an example of “first feed line”, “second feed line”, “third feed line”, and “fourth feed line” in the disclosure. “Feed point SP1A”, “feed point SP2A”, “feed point SP1B”, and “feed point SP2B” in the third embodiment respectively correspond to an example of “first feed point”, “second feed point”, “third feed point”, and “fourth feed point” in the disclosure. “Ground electrode GND23” in the third embodiment corresponds to an example of “fifth ground electrode” in the disclosure.

### Aspects

It is understood by those who are skilled in the art that the above-described exemplary embodiments are specific examples of the following aspects.
(1) An antenna module according to an aspect includes a dielectric substrate, a radiating element, first and second ground electrodes, and first and second feed lines. The radiating element has a planar shape and is disposed in or on the dielectric substrate. The first ground electrode is disposed at a position at which it faces the radiating element when the dielectric substrate is seen in a direction of a line normal to the dielectric substrate. The first feed line is disposed along a first direction, the first direction being a direction from the first ground electrode toward the radiating element, and transfers a radio-frequency signal to a first feed point of the radiating element. The second feed line is separated from the first feed line and is disposed along the first direction and transfers a radio-frequency signal to a second feed point of the radiating element. The second ground electrode protrudes from the first ground electrode and is at least partially disposed along the first feed line. The first feed point and the second feed point are shifted in different directions with respect to a center of the radiating element. When a direction from the first feed line toward the second feed line is set to a second direction and when a direction from the second feed line toward the first feed line is set to a third direction, the second ground electrode is separated from the first feed line in the third direction. At least part of the second ground electrode is disposed along the radiating element. A size of a connecting portion of the second ground electrode with the first ground electrode in the second direction is smaller than a size of the second ground electrode in the first direction.
(2) In the antenna module according to (1), a distance from the first ground electrode to a farthest end of the second ground electrode in the first direction is larger than a size of the radiating element and is smaller than or equal to 1.5 times as large as the size of the radiating element.
(3) In the antenna module according to (2), the distance from the first ground electrode to the farthest end of the second ground electrode in the first direction is shorter than a distance from the first ground electrode to a farthest end of the radiating element.
(4) In the antenna module according to one of (1) to (3), a distance between the radiating element and a portion of the second ground electrode extending along the radiating element is ½ of a size of the radiating element or smaller.
(5) In the antenna module according to one of (1) to (4), a dimension of the second ground electrode along the second direction is ½ of a size of the radiating element or smaller.
(6) The antenna module according to one of (1) to (5) further includes a third ground electrode that protrudes from the first ground electrode and that is at least partially disposed along the second feed line. The third ground electrode is separated from the second feed line in the second direction. A size of a connecting portion of the third ground electrode with the first ground electrode in the second direction is smaller than a size of the third ground electrode in the first direction.
(7) The antenna module according to one of (1) to (6) further includes a fourth ground electrode that protrudes from the first ground electrode in the first direction and that is disposed between the first feed line and the second feed line. At least part of the fourth ground electrode is disposed along the first feed line and the second feed line.
(8) In the antenna module according to (7), the fourth ground electrode includes a first electrode disposed along the first feed line and a second electrode disposed along the second feed line. A size of each of the first and second electrodes in the second direction is smaller than a size of each of the first and second electrodes in the first direction.
(9) An antenna module according to an aspect includes a dielectric substrate, first and second radiating elements, first and fifth ground electrodes, and first through fourth feed lines. The first and second radiating elements have a planar shape and are disposed separately from each other in or on the dielectric substrate. The first ground electrode is disposed at a position at which it faces the first and second radiating elements when the dielectric substrate is seen in a direction of a line normal to the dielectric substrate. The first feed line is disposed along a first direction, the first direction being a direction from the first ground electrode toward the first radiating element, and transfers a radio-frequency signal to a first feed point of the first radiating element. The second feed line is separated from the first feed line and is disposed along the first direction and transfers a radio-frequency signal to a second feed point of the first radiating element. The third feed line is disposed along the first direction, the first direction also being a direction from the first ground electrode toward the second radiating element, and transfers a radio-frequency signal to a third feed point of the second radiating element. The fourth feed line is separated from the third feed line and is disposed along the first direction and transfers a radio-frequency signal to a fourth feed point of the second radiating element. When a direction from the first radiating element toward the second radiating element is set to a second direction, the second feed line is disposed farther toward the second radiating element in the second direction than the first feed line is, and the fourth feed line is disposed farther toward the second radiating element in the second direction than the third feed line is. The first feed point and the second feed point are shifted in different directions with respect to a center of the first radiating element. The third feed point and the fourth feed point are shifted in different directions with respect to a center of the second radiating element. The fifth ground electrode protrudes from the first ground electrode and is disposed between the second feed line and the third feed line. A size of a connecting portion of the fifth ground electrode with the first ground electrode in the second direction is smaller than a size of the fifth ground electrode in the first direction. The fifth ground electrode includes a first portion disposed along the second feed line, a second portion disposed along the third feed line, a third portion disposed along the first radiating element, and a fourth portion disposed along the second radiating element.
(10) The antenna module according to one of (1) to (9) further includes a feeder circuit that supplies a radio-frequency signal to each radiating element.
(11) A communication apparatus includes the antenna module according to one of (1) to (10).

The disclosed embodiments are provided only for the purposes of illustration, but are not intended to be exhaustive or to limit the disclosure to the precise forms disclosed. It is intended that the scope of the disclosure be defined, not by the foregoing embodiments, but by the following claims. The scope of the present disclosure is to be accorded the broadest interpretation so as to encompass all such modifications and equivalent structures and functions.

### REFERENCE SIGNS LIST

10 communication apparatus
100, 100A to 100C, 100X antenna module
110 RFIC
111A to 111H, 113A to 113H, 117A, 117B switch
112AR to 112HR low-noise amplifier
112AT to 112HT power amplifier
114A to 114H attenuator
115A to 115H phase shifter
116A, 116B signal combiner/splitter
118A, 118B mixer
119A, 119B amplifier circuit
120 antenna device
121, 121A, 121B radiating element
130 dielectric substrate
141, 142, 141A, 142A, 141B, 142B feed line
200 BBIC
GND1 to GND4, GND21 to GND23, GND41, GND42, GND2A, GND3B, GND4A, GND4B, GNDX ground electrode
SP1, SP2, SP1A, SP2A, SP1B, SP2B feed point

1. An antenna module comprising:
a dielectric substrate;
a radiating element having a planar shape in or on the dielectric substrate;
a first ground electrode at a position at which the first ground electrode faces the radiating element when the dielectric substrate is seen in a direction of a line normal to the dielectric substrate;
a first feed line along a first direction, the first direction being a direction from the first ground electrode toward the radiating element, the first feed line configured to transfer a radio-frequency signal to a first feed point of the radiating element;
a second feed line separated from the first feed line and disposed along the first direction, the second feed line configured to transfer a radio-frequency signal to a second feed point of the radiating element; and
a second ground electrode that protrudes from the first ground electrode and is at least partially disposed along the first feed line, wherein
the first feed point and the second feed point are shifted in different directions with respect to a center of the radiating element,
a second direction is a direction from the first feed line toward the second feed line,
a third direction is a direction from the second feed line toward the first feed line,
the second ground electrode is separated from the first feed line in the third direction,
at least part of the second ground electrode is disposed along the radiating element, and
a dimension of a connecting portion of the second ground electrode with the first ground electrode in the second direction is smaller than a dimension of the second ground electrode in the first direction.

2. The antenna module according to claim 1, wherein a distance from the first ground electrode to a farthest end of the second ground electrode in the first direction is larger than a dimension of the radiating element and is smaller than or equal 1.5 times as large as the dimension of the radiating element.

3. The antenna module according to claim 2, wherein the distance from the first ground electrode to the farthest end of the second ground electrode in the first direction is shorter than a distance from the first ground electrode to a farthest end of the radiating element.

4. The antenna module according to claim 1, wherein a distance between the radiating element and a portion of the second ground electrode extending along the radiating element is ½ of a dimension of the radiating element or smaller.

5. The antenna module according to claim 1, wherein a dimension of the second ground electrode along the second direction is ½ of a dimension of the radiating element or smaller.

6. The antenna module according to claim 1, further comprising:
a third ground electrode that protrudes from the first ground electrode and that is at least partially disposed along the second feed line, wherein
the third ground electrode is separated from the second feed line in the second direction, and
a dimension of a connecting portion of the third ground electrode with the first ground electrode in the second direction is smaller than a dimension of the third ground electrode in the first direction.

7. The antenna module according to claim 6, wherein the second ground electrode and the third ground electrode are disposed symmetrically with respect to a centerline positioned between the first feed line and the second feed line.

8. The antenna module according to claim 1, further comprising:
a fourth ground electrode that protrudes from the first ground electrode in the first direction and is between the first feed line and the second feed line,
wherein at least part of the fourth ground electrode is disposed along the first feed line and the second feed line.

9. The antenna module according to claim 8, wherein:
the fourth ground electrode includes
a first electrode disposed along the first feed line, and
a second electrode disposed along the second feed line; and
a dimension of each of the first and second electrodes in the second direction is smaller than a dimension of each of the first and second electrodes in the first direction.

10. The antenna module according to claim 1, wherein the radiating element is substantially square, and the first feed point and the second feed point are located proximate to adjacent corners of the radiating element.

11. The antenna module according to claim 1, wherein a length of the second ground electrode in the first direction is approximately three-quarters of an effective wavelength corresponding to a predetermined frequency at which isolation between the first feed line and the second feed line is improved.

12. The antenna module according to claim 1, further comprising:
a feeder circuit that supplies a radio-frequency signal to each radiating element.

13. A communication apparatus comprising:
the antenna module according to claim 1.

14. An antenna module comprising:
a dielectric substrate;
first and second radiating elements having a planar shape that are disposed separately from each other in or on the dielectric substrate;
a first ground electrode at a position at which the first ground electrode faces the first and second radiating elements when the dielectric substrate is seen in a direction of a line normal to the dielectric substrate;
a first feed line disposed along a first direction, the first direction being a direction from the first ground electrode toward the first radiating element, the first feed line configured to transfer a radio-frequency signal to a first feed point of the first radiating element;
a second feed line that is separated from the first feed line and is disposed along the first direction, the second feed line configured to transfer a radio-frequency signal to a second feed point of the first radiating element;
a third feed line disposed along the first direction, the first direction also being a direction from the first ground electrode toward the second radiating element, and that transfers a radio-frequency signal to a third feed point of the second radiating element; and
a fourth feed line that is separated from the third feed line and is disposed along the first direction and that transfers a radio-frequency signal to a fourth feed point of the second radiating element, wherein
when a direction from the first radiating element toward the second radiating element is set to a second direction,
the second feed line is disposed farther in the second direction than the first feed line, and
the fourth feed line is disposed farther toward in the second direction than the third feed line,
the first feed point and the second feed point are shifted in different directions with respect to a center of the first radiating element, and
the third feed point and the fourth feed point are shifted in different directions with respect to a center of the second radiating element,
the antenna module further including:
a fifth ground electrode that protrudes from the first ground electrode and that is disposed between the second feed line and the third feed line, wherein
a dimension of a connecting portion of the fifth ground electrode with the first ground electrode in the second direction is smaller than a dimension of the fifth ground electrode in the first direction, and
the fifth ground electrode includes
a first portion disposed along the second feed line,
a second portion disposed along the third feed line,
a third portion disposed along the first radiating element, and
a fourth portion disposed along the second radiating element.

15. The antenna module according to claim 14, further comprising a sixth ground electrode protruding from the first ground electrode, wherein the sixth ground electrode is at least partially disposed along the first feed line.

16. The antenna module according to claim 15, further comprising a seventh ground electrode protruding from the first ground electrode, wherein the seventh ground electrode is at least partially disposed along the fourth feed line.

17. The antenna module according to claim 14, further comprising:
a first intermediate ground electrode disposed between the first feed line and the second feed line; and
a second intermediate ground electrode disposed between the third feed line and the fourth feed line.

18. The antenna module according to claim 14, further comprising:
a feeder circuit that supplies a radio-frequency signal to each radiating element.

19. A communication apparatus comprising:
the antenna module according to claim 14.
